(19) United States
(12) Patent Application Publication
(10) Pub. No.: US 2021/0192481 A1
(43) Pub. Date: Jun. 24, 2021

(54) INFORMATION PROCESSING DEVICE AND METHOD

(71) Applicant: TOSHIBA TEC KABUSHIKI KAISHA, Tokyo (JP)

(72) Inventor: Naoto Kakinoki, Izunokuni Shizuoka (JP)

(21) Appl. No.: 16/940,545

(22) Filed: Jul. 28, 2020

(30) Foreign Application Priority Data
Dec. 24, 2019 (JP) 2019-232477

(51) Int. Cl. G06Q 20/20; G06Q 10/00

(52) U.S. Cl. CPC G06Q 20/202; G06Q 10/20

(57) ABSTRACT

According to one embodiment, an information processing device includes an acquisition unit configured to acquire a work content related to a predetermined work item performed on the device to be maintained, a determination unit configured to determine whether or not the work content acquired by the acquisition unit is appropriate based on a checklist that stores a work content serving as a reference for the work item, and an output unit configured to output a determination result of the determination unit.

### CROSS-REFERENCE TO RELATED APPLICATION

This application is based upon and claims the benefit of priority from Japanese Patent Application No. 2019-232477, filed in Dec. 24, 2019, the entire contents of which are incorporated herein by reference.

### FIELD

Embodiments described herein relate generally to an information processing device and a method.

### BACKGROUND

In the related art, commodity sales data processing devices such as POS terminals (Point of Sales) have been used in stores such as supermarkets. The commodity sales data processing device maintains an environment where a stable operation is possible by maintenance work such as a data update performed by a maintenance person. For example, in the related art, a technique has been proposed in which a checklist is displayed on a display unit of a portable terminal carried by a maintenance person, and maintenance work can be performed while looking at the displayed checklist.

In the interim, since the above-mentioned maintenance work is performed by a manual operation of a maintenance person, there is a possibility that a work mistake such as a work omission or a work error may occur. For example, in the maintenance work in which the order of execution is determined, if the operation is performed while a work mistake occurs, a backtracking work occurs, and thus the work time and the number of work steps may increase.

In the method of the related art which uses a checklist, the work check is left to the maintenance person himself/herself. If the maintenance person makes a mistake in checking the work or does not check the work, there is a possibility to proceed with the work without noticing the work mistake, which leaves room for further improvement.

### DESCRIPTION OF THE DRAWINGS

FIG. 1 is a diagram illustrating an example of a maintenance system according to a first embodiment;

FIG. 2 is a diagram illustrating an example of a hardware configuration of a POS terminal according to the first embodiment;

FIG. 3 is a diagram illustrating an example of a hardware configuration of a server device according to the first embodiment;

FIG. 4 is a diagram illustrating an example of a hardware configuration of a maintenance terminal according to the first embodiment;

FIG. 5 is a diagram illustrating an example of a checklist according to the first embodiment;

FIG. 6 is a diagram illustrating an example of a functional configuration of the maintenance system according to the first embodiment;

FIG. 7 is a diagram illustrating an example of an execution status registered in the checklist according to the first embodiment;

FIG. 8 is a flowchart illustrating an example of a process executed by the POS terminal according to the first embodiment;

FIG. 9 is a flowchart illustrating an example of a process executed by the server device according to the first embodiment;

FIG. 10 is a flowchart illustrating an example of a process executed by the maintenance terminal according to the first embodiment;

FIG. 11 is a diagram illustrating an example of a maintenance system according to a second embodiment;

FIG. 12 is a diagram illustrating an example of a hardware configuration of a server device according to the second embodiment;

FIG. 13 is a diagram illustrating an example of a functional configuration of the server device according to the second embodiment;

FIG. 14 is a diagram illustrating an example of a checklist according to Modification 1;

FIG. 15 is a diagram illustrating an example of a checklist according to Modification 2; and

FIG. 16 is a diagram illustrating an example of a maintenance system according to Modification 3.

### DETAILED DESCRIPTION

An aspect of the present disclosure is to provide an information processing device and a method that can improve the efficiency of maintenance work.

In general, according to one embodiment, an information processing device includes an acquisition means, a determination means, and an output means. The acquisition means acquires a work content related to a predetermined work item performed by the device to be maintained. The determination means determines whether or not the work content acquired by the acquisition means is appropriate based on a checklist that stores a work content serving as a reference for the work item. The output means outputs a determination result of the determination means.

Hereinafter, a maintenance system according to an embodiment will be described with reference to the drawings. A POS terminal used in a store will be described as a device to be maintained. The present disclosure is not limited by the embodiments described below.

### First Embodiment

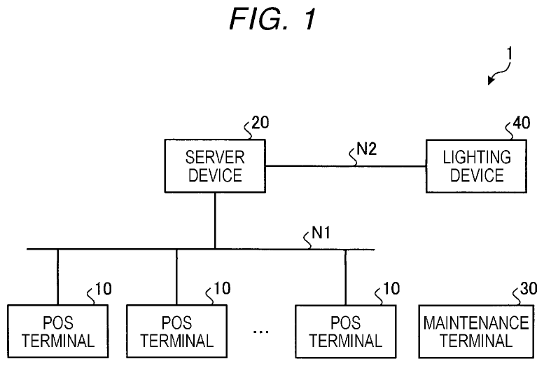

FIG. 1 is a diagram illustrating an example of a maintenance system according to the present embodiment. As shown in FIG. 1, a maintenance system 1 includes a POS terminal 10, a server device 20, and a maintenance terminal 30. Further, the maintenance system 1 includes a lighting device 40.

The POS terminal 10 and the server device 20 are connected via a network N1 such as a local area network (LAN) provided in the store. The server device 20 and the lighting device 40 are connected via a cable N2 such as a control line. That is, the POS terminal 10 and the lighting device 40 are connected via the server device 20. The number of POS terminals 10 and the number of lighting devices 40 are not limited to the example of FIG. 1.

The POS terminal 10 is an example of a commodity sales data processing device that is provided in a checkout section in a store and performs a settlement process for a commodity purchased by a customer. In the present embodiment, the POS terminal 10 is a device to be maintained on which maintenance work such as data update is performed by a maintenance person. The POS terminal 10 is not limited to a normal POS terminal operated by a store clerk, but also includes a self-service type POS terminal operated by a customer. In addition, the POS terminal 10 includes a semi-self-service type POS terminal in which a clerk operates sales registration and a customer performs a checkout operation.

The POS terminal 10 includes a clerk display unit 110 including a backlight 1101 described below. The POS terminal 10 can perform visible light communication by modulating the intensity of light emitted from the backlight 1101. In addition, the visible light communication can use a known and public technology.

The server device 20 is, for example, a store server placed in a store and receives various information transmitted from each of the POS terminals 10. In addition, the server device 20 is connected to the lighting device 40 and controls the light emission of the lighting device 40.

A plurality of lighting devices 40 are installed, for example, on the ceiling of the store and illuminate the entrance and exit of the store, display portions where commodities are displayed, the checkout section, and the like from above. The server device 20 can perform visible light communication by modulating the intensity of light emitted from the lighting device 40.

In the present embodiment, a light source device such as light emitting diode (LED) lighting is used as a light source of the backlight 1101 and the lighting device 40 described later. In the LED lighting, the modulation frequency can be set high in particular. Therefore, by using LED lighting as the light source of the backlight 1101 and the lighting device 40, the light intensity can be modulated in a high frequency band in which human eyes do not sense flickering.

The maintenance terminal 30 is an example of an information processing device. The maintenance terminal 30 is carried by a maintenance person and used when performing maintenance work on the POS terminal 10. As the maintenance terminal 30, for example, a portable terminal device such as a smartphone or a tablet terminal can be used. The maintenance terminal 30 can receive information transmitted by visible light communication by analyzing image data captured by an imaging unit 310 described below.

Next, the device configuration of the above-described maintenance system 1 will be described.

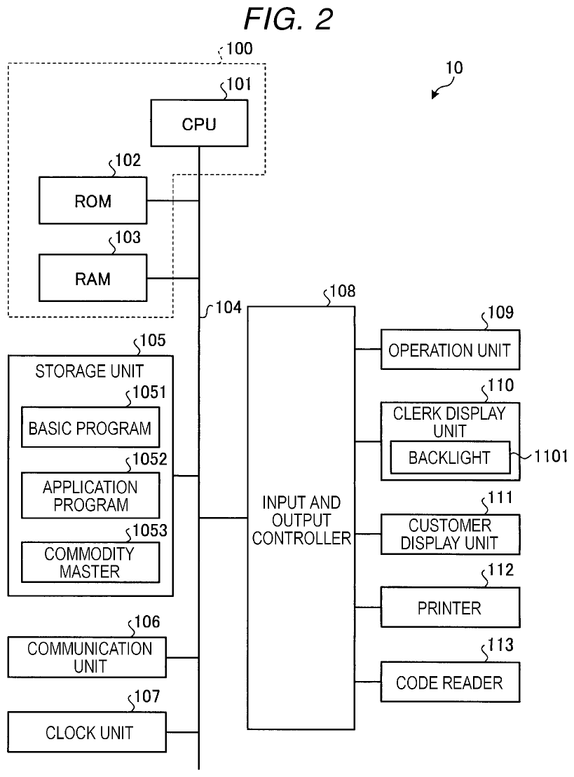

First, the hardware configuration of the POS terminal 10 will be described. FIG. 2 is a diagram illustrating an example of the hardware configuration of the POS terminal 10. As shown in FIG. 2, the POS terminal 10 includes a central processing unit (CPU) 101, a read only memory (ROM) 102, and a random access memory (RAM) 103.

The CPU 101 is an example of a processor and controls the operation of the POS terminal 10 in an integrated manner. The ROM 102 stores various programs. The RAM 103 is a workspace for loading programs and various data. The CPU 101, the ROM 102, and the RAM 103 are connected to each other via a bus 104. The CPU 101, the ROM 102, and the RAM 103 constitute a control unit 100 configuring a computer. In the control unit 100, the CPU 101 executes various processes by operating in accordance with a program stored in the ROM 102 or a storage unit 105 described later and loaded in the RAM 103.

The storage unit 105 is connected to the control unit 100 via the bus 104. The storage unit 105 is a storage device such as a solid state drive (SSD), a hard disk drive (HDD), and a flash memory, and retains the stored contents even when the power is turned off.

The storage unit 105 stores, for example, various data such as a basic program 1051, an application program 1052, a commodity master 1053, and the like. The basic program 1051 is a program for realizing the basic operation of the POS terminal 10, such as an operating system. The application program 1052 is a program for realizing a predetermined function related to a commercial transaction (for example, a function related to a settlement process). The commodity master 1053 is a database or the like that stores information on commodities sold in the store. For example, the commodity master 1053 stores various commodity information such as a commodity name and a unit price in association with a commodity code for identifying each commodity.

Further, a communication unit 106 and a clock unit 107 are connected to the control unit 100 via the bus 104. The communication unit 106 is a wired or wireless communication interface that can be connected to the network N1. The communication unit 106 communicates with the server device 20 and the like via the network N1. The clock unit 107 is a clock device such as a real time clock (RTC). The clock unit 107 measures, for example, the current date and time.

An operation unit 109, the clerk display unit 110, a customer display unit 111, a printer 112, a code reader 113, and the like are connected to the control unit 100 via the bus 104 and an input and output controller 108.

The operation unit 109 includes a keyboard including various operation buttons, a pointing device, and the like. The operation unit 109 receives an operation of the operator and outputs the content of the received operation to the control unit 100.

The clerk display unit 110 is a display device such as a liquid crystal display (LCD) including the backlight 1101. The backlight 1101 is configured by a light source device such as an LED as described above. The backlight 1101 can perform visible light communication by modulating light emitted by the light source device under the control of the control unit 100.

In addition, the clerk display unit 110 displays various screens, such as a screen related to the operation of the POS terminal 10, a screen related to the settlement process for a commodity, and a screen indicating the data update status, under the control of the control unit 100. The operation unit 109 may be, for example, a touch panel provided on a surface of the clerk display unit 110.

The customer display unit 111 is configured by a display device similar to the clerk display unit 110, for example. Under the control of the control unit 100, the customer display unit 111 displays a screen presented to the customer, such as a screen related to the settlement process for a commodity.

The printer 112 is, for example, a thermal printer including a thermal head. The printer 112 prints commodity information and information related to the settlement on long thermal paper to dispense a receipt. The code reader 113 is a reading device that reads a code symbol such as a bar code attached to a commodity. The code reader 113 receives an input of a commodity to be purchased by a customer by reading a commodity code held by the code symbol.

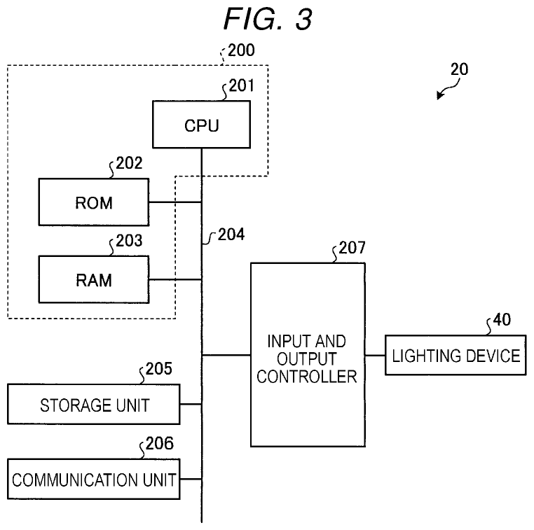

Next, a hardware configuration of the server device 20 will be described. FIG. 3 is a diagram illustrating an example of a hardware configuration of the server device 20. As shown in FIG. 3, the server device 20 includes a CPU 201, a ROM 202, and a RAM 203.

The CPU 201 is an example of a processor and controls the operation of the server device 20 in an integrated manner. The ROM 202 stores various programs. The RAM 203 is a workspace for loading programs and various data. The CPU 201, the ROM 202, and the RAM 203 are connected to each other via a bus 204. The CPU 201, the ROM 202, and the RAM 203 constitute a control unit 200 configuring a computer. In the control unit 200, the CPU 201 executes various processes by operating in accordance with a program stored in the ROM 202 or a storage unit 205 described later and loaded in the RAM 203.

The storage unit 205 and a communication unit 206 are connected to the control unit 200 via the bus 204. The storage unit 205 is a storage device such as an SSD, an HDD, and a flash memory, and retains the stored contents even when the power is turned off. The storage unit 205 stores various programs executed by the CPU 201 and setting information. The communication unit 206 is a wired or wireless communication interface that can be connected to the network N1. The communication unit 206 communicates with the POS terminal 10 and the like via the network N1.

The lighting device 40 is connected to the control unit 200 via the bus 204 and an input and output controller 207. The lighting device 40 includes a light source device such as an LED lighting as described above. The lighting device 40 can perform visible light communication by modulating light emitted from the light source device under the control of the control unit 200.

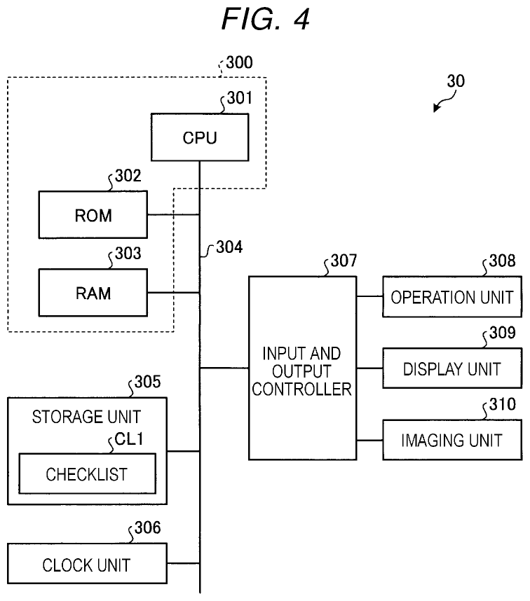

Next, the hardware configuration of the maintenance terminal 30 will be described. FIG. 4 is a diagram illustrating an example of a hardware configuration of the maintenance terminal 30. As shown in FIG. 4, the maintenance terminal 30 includes a CPU 301, a ROM 302, and a RAM 303.

The CPU 301 is an example of a processor and controls the operation of the maintenance terminal 30 in an integrated manner. The ROM 302 stores various programs. The RAM 303 is a workspace for loading programs and various data. The CPU 301, the ROM 302, and the RAM 303 are connected to each other via a bus 304. The CPU 301, the ROM 302, and the RAM 303 constitute a control unit 300 configuring a computer. In the control unit 300, the CPU 301 executes various processes by operating in accordance with a program stored in the ROM 302 or a storage unit 305 described below and loaded in the RAM 303.

The storage unit 305 is connected to the control unit 300 via the bus 304. The storage unit 305 includes an SSD, an HDD, a flash memory, and the like, and retains the stored contents even when the power is turned off. The storage unit 305 stores various programs executed by the CPU 301 and setting information. Further, the storage unit 305 stores a checklist CL1 indicating a work procedure of a maintenance work performed by the maintenance person on the POS terminal 10.

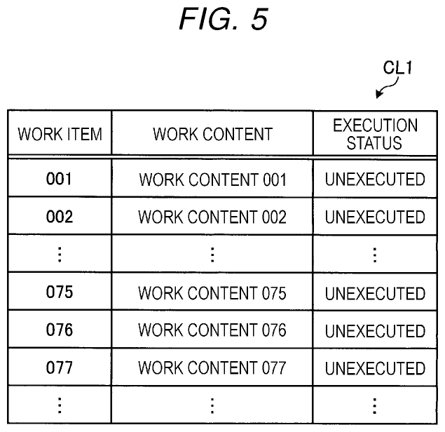

FIG. 5 is a diagram illustrating an example of the checklist CL1. As shown in FIG. 5, the checklist CL1 stores work items, work contents, and execution statuses in association with each other. Here, an identification number is set in the work item to identify a series of work contents set in advance. In this embodiment, the work item also functions as a process number that defines the order in which each work is performed. In the work content, a work content as a reference to be performed by the maintenance person is set. In the execution status, information indicating the execution status of each work is input in the processing described below. In the execution status, for example, information such as “unexecuted” indicating that the work is not performed, “completed” indicating that the work was completed, and “work in progress” indicating that the work is being performed is input. In the initial state of the checklist CL1 before the start of the work, it is assumed that the execution status of any work item is set to “unexecuted”.

For example, the maintenance person using the maintenance terminal 30 displays the above-described checklist CL1 on a display unit 309 described later and performs the maintenance work on the POS terminal 10 while checking the work content of each work item registered in the checklist CL1. In this case, the checklist CL1 may be displayed by a manual operation of a maintenance person via an operation unit 308 described later or may be automatically displayed under the control of an output unit 353 described later.

The hardware configuration of the maintenance terminal 30 is not limited to the example of FIG. 4. For example, the maintenance terminal 30 may include a communication device that can be connected to the network N1, a communication device that can be connected to a public line network, and the like.

Returning to FIG. 4, a clock unit 306 is connected to the control unit 300 via the bus 304. The clock unit 306 is a clock device such as an RTC. The clock unit 306 measures, for example, the current date and time.

Further, the operation unit 308, the display unit 309, the imaging unit 310, and the like are connected to the control unit 300 via the bus 304 and an input and output controller 307.

The operation unit 308 includes various operation buttons and outputs key information corresponding to the operation of the operator to the control unit 300. The display unit 309 is a display device such as an LCD. The display unit 309 displays various screens under the control of the control unit 300. The operation unit 308 may be, for example, a touch panel provided on the surface of the display unit 309.

The imaging unit 310 is an imaging device including an image sensor such as a charge coupled device (CCD) or a complementary MOS (CMOS). The imaging unit 311 outputs image data obtained by imaging to the control unit 300.

In the present embodiment, the imaging unit 311 captures a moving image as image data. The imaging unit 311 is used to receive light emitted by the clerk display unit 110 (backlight 1101) and the lighting device 40. A configuration may be adopted in which a light receiving device for visible light communication is provided instead of the imaging unit 311.

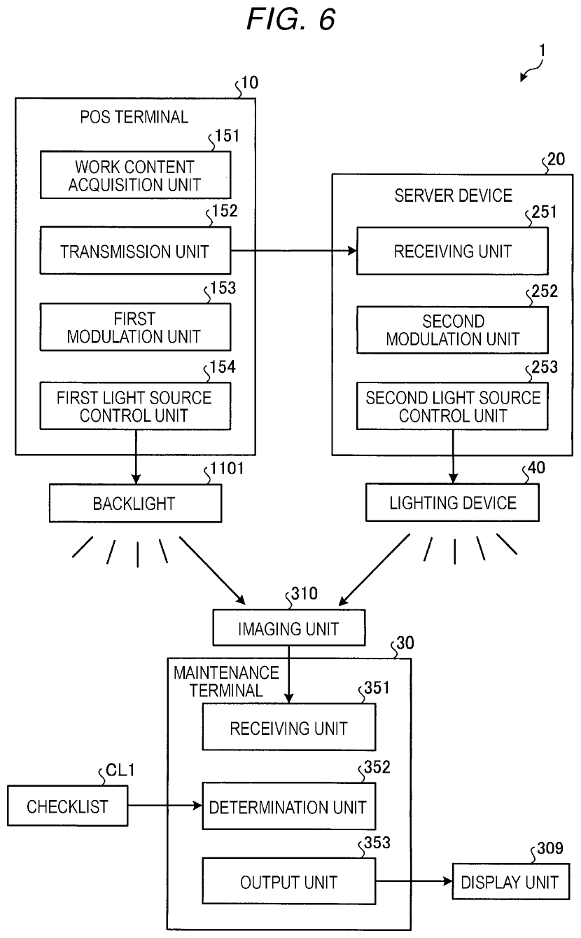

Next, a functional configuration of the maintenance system 1 will be described. FIG. 6 is a diagram illustrating an example of a functional configuration of the maintenance system 1.

As shown in FIG. 6, the POS terminal 10 includes a work content acquisition unit 151, a transmission unit 152, a first modulation unit 153, and a first light source control unit 154 as functional units. These functional units are activated when the POS terminal 10 is shifted to a maintenance mode for maintenance work by a predetermined operation via the operation unit 109, for example.

Some or all of the above-described functional units may have a software configuration realized by cooperation between a processor (for example, CPU 101) of the POS terminal 10 and a program stored in a memory (for example, ROM 102, storage unit 105). For example, some or all of the functional units described above may be implemented by the basic program 1051, the application program 1052 for the maintenance and inspection work, and the like. Further, some or all of the functional units described above may have a hardware configuration realized by a dedicated circuit or the like mounted on the POS terminal 10.

The work content acquisition unit 151 acquires the content of the maintenance work performed on the own device by the maintenance person as the work content. Specifically, in response to an operation via the operation unit 109 or the like, the work content acquisition unit 151 acquires the content of the operation, the content of a process executed in response to the operation, and the like as the work content. For example, the work content acquisition unit 151 acquires the work content at the start and end of the process. The work content is not limited to the above and may include other information. For example, the time at which the process started or the time at which the process ended may be acquired as the work content.

The transmission unit 152 transmits the work content acquired by the work content acquisition unit 151 to the server device 20. As will be described later, the work content transmitted to the server device 20 is transmitted by visible light communication via the lighting device 40 under the control of the server device 20.

The first modulation unit 153 generates a control signal for transmitting the work content acquired by the work content acquisition unit 151 by visible light communication. Specifically, the first modulation unit 153 superimposes information indicating the work content acquired by the work content acquisition unit 151 on a control signal for controlling the light emission of the backlight 1101, thereby generating a control signal for the visible light communication.

The first light source control unit 154 controls the light emission of the backlight 1101 based on the control signal generated by the first modulation unit 153. The first light source control unit 154 controls the light emission of the backlight 1101, thereby transmitting the work content acquired by the work content acquisition unit 151 by visible light communication.

The server device 20 includes a receiving unit 251, a second modulation unit 252, and a second light source control unit 253 as functional units.

Some or all of the functional units described above may have a software configuration realized by cooperation between a processor (for example, CPU 201) of the server device 20 and a program stored in a memory (for example, ROM 202, storage unit 205). In addition, some or all of the functional units described above may have a hardware configuration realized by a dedicated circuit or the like mounted on the server device 20.

The receiving unit 251 receives information transmitted from the POS terminal 10. Specifically, the receiving unit 251 receives the work content transmitted from the transmission unit 152 of the POS terminal 10.

The second modulation unit 252 generates a control signal for transmitting the work content received by the receiving unit 251 by visible light communication. Specifically, the second modulation unit 252 superimposes information indicating the work content received by the receiving unit 251 on a control signal for controlling the light emission of the lighting device 40, thereby generating a control signal for the visible light communication.

The second light source control unit 253 controls the light emission of the lighting device 40 based on the control signal generated by the second modulation unit 252. The second light source control unit 253 controls the light emission of the lighting device 40 to transmit the end time received by the receiving unit 251, that is, the work content related to the maintenance work performed by the POS terminal 10 by visible light communication.

The maintenance terminal 30 includes a receiving unit 351, a determination unit 352, and an output unit 353 as functional units.

Some or all of the functional units described above may have a software configuration realized by cooperation between a processor (for example, CPU 301) of the maintenance terminal 30 and a program stored in a memory (for example, ROM 302, storage unit 305). Further, some or all of the functional units described above may have a hardware configuration realized by a dedicated circuit or the like mounted on the maintenance terminal 30.

The receiving unit 351 is an example of an acquisition unit. The receiving unit 351 receives the information transmitted by visible light communication by analyzing the image data captured by the imaging unit 311. Specifically, the receiving unit 351 acquires information superimposed on the light by analyzing the intensity of the light received by the imaging unit 311.

For example, when the clerk display unit 110 is imaged by the imaging unit 311, the receiving unit 351 analyzes the intensity of light emitted from the backlight 1101 captured in a moving image, thereby acquiring the work content superimposed on the light. In addition, for example, when the lighting device 40 is imaged by the imaging unit 311, the receiving unit 351 analyzes the intensity of light emitted from the lighting device 40 captured in a moving image, thereby acquiring the work content superimposed on the light.

The determination unit 352 is an example of a determination unit. The determination unit 352 determines whether or not the work content received by the receiving unit 351 is appropriate based on the checklist CL1 stored in the storage unit 305.

Specifically, the determination unit 352 compares each of the work contents registered in the checklist CL1 with the work content received by the receiving unit 351 to determine whether or not the work content being performed on the POS terminal 10 matches the work content of the list CL1. When the work content received by the receiving unit 351 matches the work content of the checklist CL1, the determination unit 352 determines that the work content is appropriate and registers the current work status in the execution status column associated with the work content of the corresponding checklist CL1.

For example, when the work content received by the receiving unit 351 indicates the start of the work content “work content 001” of the work item “001” illustrated in FIG. 5, the determination unit 352 changes the execution status “unexecuted” of this work item to “work in progress”. For example, when the work content received by the receiving unit 351 indicates the end of the work content “work content 001” of the work item “001” illustrated in FIG. 5, the determination unit 352 changes the execution status “work in progress” of this work item to “completed”.

When the work content received by the receiving unit 351 indicates a work content other than the work contents registered in the checklist CL1, the determination unit 352 may exclude the other work content from the determination target or may determine to be inappropriate. In the latter case, for example, when the other work content indicates a predetermined work content (for example, a work having a possibility of data loss), it may be determined to be inappropriate.

Meanwhile, when the work is performed in the order of the work items registered in the checklist CL1, the execution status is sequentially changed to “completed” in the order of the work item numbers. However, if a work mistake such as a work omission or a work error occurs, the work item of the next stage is changed to “work in progress” or “completed” while the execution status of the previous stage is “unexecuted” or “work in progress”.

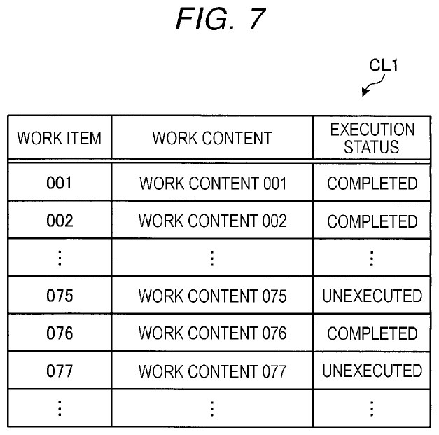

For example, the checklist CL1 in FIG. 7 shows an example in which the work item “076” is performed first without performing the work item “075”. As described above, when a work mistake such as a work omission or a work error occurs, the work item with the next stage number is “work in progress” (or “completed) while the work item with the preceding number is “unexecuted”. FIG. 7 is a diagram illustrating an example of the execution status registered in the checklist CL1.

Therefore, the determination unit 352 determines whether or not the work is performed in the order of the work items by checking the execution status registered in the work status column of each work item. Specifically, when the work item of the preceding number is “completed” and the work item of the subsequent number is changed to “work in progress” or “completed”, the determination unit 352 determines that the work is performed in the order of the work items and determines to be appropriate. In addition, when the work item of the subsequent number is changed to “work in progress” or “completed” while the work item of the preceding number is “unexecuted”, the determination unit 352 determines that the work is not performed in the order of the work items and determines to be inappropriate. For example, in the example of FIG. 7, the determination unit 352 determines to be appropriate since the work item “076” is performed before the work item “075”, and determines that the work item “075” is skipped.

The output unit 353 is an example of an output unit. The output unit 353 outputs the determination result of the determination unit 352. Specifically, the output unit 353 causes the display unit 309 to display and output the checklist CL1 in which the execution status is registered by the determination unit 352. In addition, when the determination unit 352 determines to be inappropriate, the output unit 353 causes the display unit 309 to display and output a screen notifying the fact.

For example, when the determination unit 352 determines that the work content other than the work contents registered in the checklist CL1 is inappropriate, the output unit 353 displays a screen for instructing suspension of the work. Further, for example, when the determination unit 352 determines that a specific work item is skipped, the output unit 353 displays a screen to notify that a work mistake such as a work omission or a work error occurred for the work content of the specific work number.

The device to which the output unit 353 outputs data is not limited to the display unit 309. For example, when a printer device is connected to the maintenance terminal 30, the printer device may be used as an output destination.

As described above, in the maintenance system 1, when the maintenance work is started by the POS terminal 10 by the maintenance person, the POS terminal 10 transmits the work content by visible light communication through the clerk display unit 110 and the lighting device 40. Therefore, the maintenance person can input the work content being performed on the POS terminal 10 to the maintenance terminal 30 by pointing the imaging unit 311 of the maintenance terminal 30 carried by the maintenance person to the clerk display unit 110 or the lighting device 40.

As a result, in the maintenance system 1, even in an environment where the maintenance terminal 30 cannot be connected to the network N1 or the POS terminal 10 due to, for example, security reasons, the work content being performed on the POS terminal 10 can be transmitted to the maintenance terminal 30.

Further, the maintenance terminal 30 compares the work content received by the visible light communication with the checklist CL1 to determine whether or not the work content being performed by the POS terminal 10 is appropriate. Then, the maintenance terminal 30 notifies the maintenance person of information by displaying the determination result on the display unit 309.

Thereby, the maintenance person can easily confirm via the maintenance terminal 30 whether or not the maintenance work being performed on the POS terminal 10 is being performed in accordance with the regular procedure registered in the checklist CL1. Therefore, the maintenance person can proceed the work while checking whether or not the maintenance work performed by the maintenance person is appropriate for each work item. Thus, even if a work mistake such as a work omission or a work error occurs, the maintenance person can quickly respond. In addition, even when a backtracking work occurs due to a work mistake, the work time and the number of work steps required for the backtracking work can be reduced, so that the efficiency of the maintenance work can be improved.

Hereinafter, an operation example of the above-described maintenance system 1 will be described.

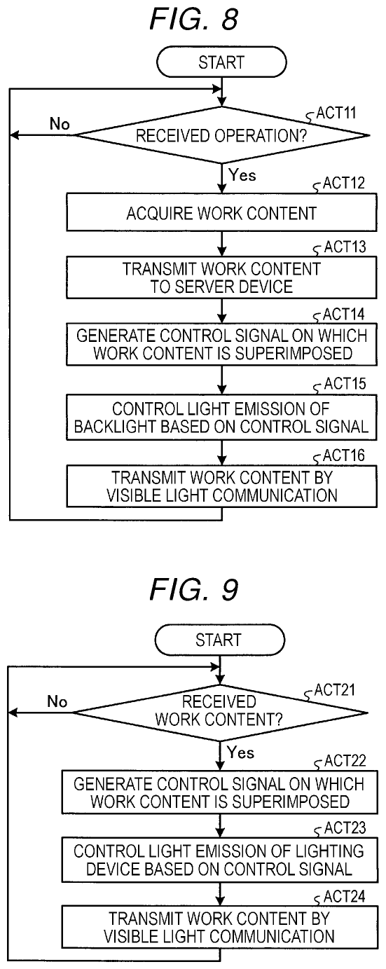

First, an operation example of the POS terminal 10 will be described with reference to FIG. 8. FIG. 8 is a flowchart illustrating an example of a process executed by the POS terminal 10. It is assumed that this process is executed while the maintenance work on the POS terminal 10 is being performed.

First, the work content acquisition unit 151 waits until an operation on the own device is received (ACT 11; No). Upon receiving the operation via the operation unit 109 (ACT 11; Yes), the work content acquisition unit 151 acquires the content of the operation and the content of the process accompanying the operation as the work content (ACT 12).

Subsequently, the transmission unit 152 transmits the work content acquired in ACT 12 to the server device 20 to transmit the work content being performed on the own device through visible light communication via the lighting device 40 (ACT 13).

Subsequently, the first modulation unit 153 generates a control signal on which the work content acquired in ACT 12 is superimposed (ACT 14). Next, the first light source control unit 154 controls the light emission of the backlight 1101 based on the control signal generated in ACT 14 (ACT 15), thereby transmitting the work content being performed on the own device by visible light communication using the backlight 1101 (ACT 16). Then, the first light source control unit 154 returns the process to ACT 11.

Accordingly, the maintenance terminal 30 can receive the work content being performed on the POS terminal 10 by visible light communication by imaging the clerk display unit 110 with the imaging unit 310.

Next, an operation example of the server device 20 will be described with reference to FIG. 9. FIG. 9 is a flowchart illustrating an example of a process performed by the server device 20.

First, the receiving unit 251 waits until the work content is transmitted from the POS terminal 10 (ACT 21; No). Upon receiving the work content from the POS terminal 10 (ACT 21; Yes), the receiving unit 251 causes the process to proceed to ACT 22.

Subsequently, the second modulation unit 252 generates a control signal for visible light communication on which the work content received in ACT 21 is superimposed (ACT 22). Next, the second light source control unit 253 controls the light emission of the lighting device 40 based on the control signal generated in ACT 22 (ACT 23), thereby transmitting the work content by visible light communication using the lighting device 40 (ACT 24). Then, the second light source control unit 253 returns the process to ACT 21.

Thereby, the maintenance terminal 30 can receive the work content being performed on the POS terminal 10 by visible light communication by imaging the lighting device 40 with the imaging unit 310.

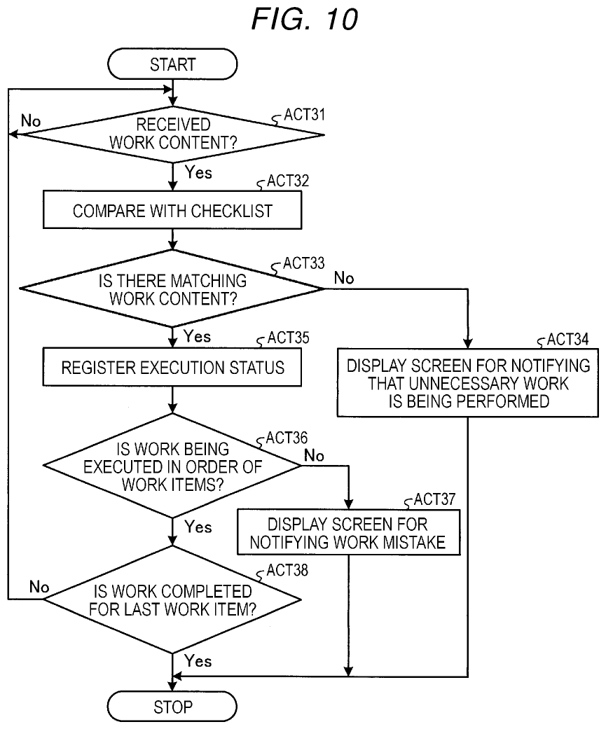

Next, an operation example of the maintenance terminal 30 will be described with reference to FIG. 10. FIG. 10 is a flowchart illustrating an example of a process executed by the maintenance terminal 30. It is assumed that the checklist CL1 is displayed on the display unit 309 as a premise of this process.

First, the receiving unit 351 monitors the image data captured by the imaging unit 311 and waits until receiving the work content transmitted by visible light communication (ACT 31). When the work content is received (ACT 31; Yes), the determination unit 352 compares the received work content with each of the work contents registered in the checklist CL1 (ACT 32), and determines whether or not there is a matching work content (ACT 33).

If there is no matching work content (ACT 33; No), the determination unit 352 determines that the work is inappropriate, displays a screen notifying that unnecessary work is being performed (ACT 34), and ends this process.

When it is determined that there is a matching work content (ACT 33; Yes), the determination unit 352 registers the current execution status in the execution status column of the matched work content (ACT 35). The output unit 353 displays the execution status registered in ACT 35 in the corresponding execution status column of the checklist CL1 displayed on the display unit 309.

Subsequently, the determination unit 352 determines whether or not the maintenance work is being performed in the order of the work items based on the execution status registered in the execution status column of each work item (ACT 36). Here, if the work is not performed in the order of the work items (ACT 36; No), the determination unit 352 determines that the work is inappropriate, displays a screen for notifying that a work mistake such as a work omission or a work error occurred (ACT 37), and ends this process.

On the other hand, when it is determined in ACT 36 that the maintenance work is performed in the order of the work items (ACT 36; Yes), the determination unit 352 determines whether or not the last work item registered in the checklist CL1 was performed (ACT 38). When there is an unexecuted work item (ACT 38; No), the determination unit 352 returns the process to ACT 31. When the last work item was completed (ACT 38; Yes), the determination unit 352 ends the process.

As described above, in the maintenance system 1, when the maintenance work on the POS terminal 10 is started by the maintenance person, the work contents being performed on the POS terminal 10 are transmitted by the visible light communication via the clerk display unit 110 and the lighting device 40. Further, in the maintenance system 1, when the work content transmitted by the visible light communication is received by the maintenance terminal 30, the work content is compared with the checklist CL1, and the maintenance terminal 30 displays a screen indicating whether or not the work content is appropriate.

According to the maintenance system 1 described above, it is possible to notify the maintenance person having the maintenance terminal 30 whether or not the work content being performed on the POS terminal 10 is appropriate. Accordingly, the maintenance system 1 can notify in real time whether or not the work content performed by the maintenance person is appropriate. Therefore, even if a work mistake such as a work omission or a work error occurs, the maintenance system 1 can quickly respond. In addition, the maintenance system 1 can thereby reduce the work time and the number of work steps required for a backtracking work even when the backtracking work occurs due to the occurrence of a work mistake. Therefore, the efficiency of the maintenance work can be improved.

In addition, according to the maintenance system 1, by performing visible light communication using the backlight 1101 or the lighting device 40, the work content being performed on the POS terminal 10 can be transmitted to the maintenance terminal 30 without connecting the maintenance terminal 30 to the network N1. Thus, even in an environment where the maintenance terminal 30 cannot be connected to the network N1 or the POS terminal 10, the work content performed on the POS terminal 10 can be transmitted to the maintenance terminal 30. Therefore, the maintenance person can acquire the work content performed on the POS terminal 10 by the maintenance terminal 30 by imaging the clerk display unit 110 and the lighting device 40 without performing a procedure related to the communication with the POS terminal 10. Therefore, the efficiency of maintenance work can be improved.

### Second Embodiment

Next, a second embodiment will be described. In the first embodiment described above, the case where the POS terminal 10 transmits the work content to the server device 20 via the network N1 is described. However, the method of transmitting the work content to the server device 20 is not limited thereto.

Therefore, in the present embodiment, a case where the end time information can be transmitted to the server device 20 using visible light communication will be described. The same components as those of the first embodiment are denoted by the same reference numerals and the description thereof is omitted.

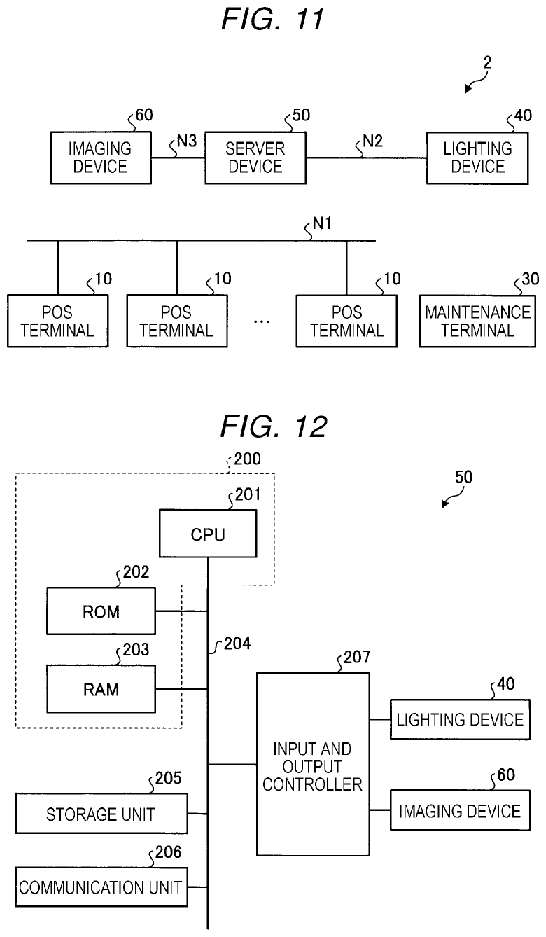

FIG. 11 is a diagram illustrating an example of a maintenance system according to the present embodiment. As shown in FIG. 11, the maintenance system 2 includes the POS terminal 10, a server device 50, the maintenance terminal 30, and the lighting device 40. Further, the maintenance system 2 includes an imaging device 60. Here, the server device 50 and the lighting device 40 are connected via the cable N2 such as a control line. The server device 50 and the imaging device 60 are connected via a cable N3 such as a data transmission line. In the present embodiment, it is assumed that the server device 50 is disconnected from the network N1.

The imaging device 60 is an imaging device including an image sensor such as a CCD or a CMOS. The imaging device 60 is, for example, a monitoring camera or the like installed on the ceiling or the like in an area where the POS terminal 10 is provided, and can image at least the clerk display unit 110 provided in the POS terminal 10.

In the present embodiment, the imaging device 60 captures a moving image as image data. The imaging device 60 is used for receiving light emitted by the clerk display unit 110 (backlight 1101). Instead of the imaging device 60, a light receiving device for visible light communication may be included.

The server device 50 is a device corresponding to the server device 20 of the first embodiment described above. The server device 50 has, for example, a hardware configuration illustrated in FIG. 12. Here, FIG. 12 is a diagram illustrating an example of a hardware configuration of the server device 50.

As shown in FIG. 12, the server device 50 includes the control unit 200 having a computer configuration such as the CPU 201, the ROM 202, and the RAM 203. Further, the storage unit 205 and the communication unit 206 are connected to the control unit 200 via the bus 204. The lighting device 40 and the imaging device 60 are connected to the control unit 200 via the bus 204 and the input and output controller 207 and the like. Image data captured by the imaging device 60 is input to the control unit 200.

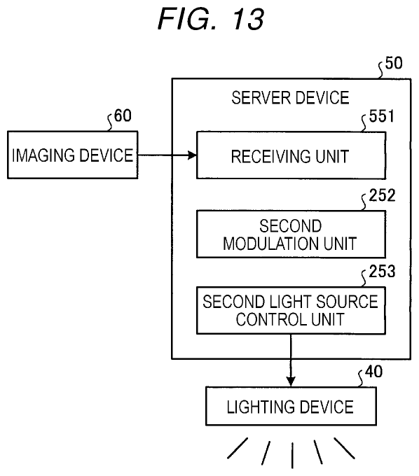

The server device 50 has, for example, a functional configuration illustrated in FIG. 13. Here, FIG. 13 is a diagram illustrating an example of a functional configuration of the server device 50.

As illustrated in FIG. 13, the server device 50 includes a receiving unit 551, the second modulation unit 252, and the second light source control unit 253 as functional units.

Here, the receiving unit 551 is a functional unit replacing the receiving unit 251 described above. The receiving unit 551 receives information transmitted by visible light communication by analyzing the image data captured by the imaging device 60. Specifically, the receiving unit 551 receives the information superimposed on the light by analyzing the intensity (vibration) of the light received by the imaging device 60.

For example, the receiving unit 551 receives the work content superimposed on the light by analyzing the intensity of light emitted from the backlight 1101 of the clerk display unit 110 from the image data of the clerk display unit 110 captured by the imaging device 60. That is, the POS terminal 10 and the server device 50 of this embodiment exchange the work content by visible light communication.

The second modulation unit 252 performs the same operation as that of the above-described first embodiment based on the end time received by the receiving unit 551. Thus, the server device 50 can transmit the end time of the update processing being executed on the POS terminal 10 to the maintenance terminal 30 by visible light communication via the lighting device 40, similarly to the server device 20.

Next, an operation example of the server device 50 will be described with reference to the above-described flowchart of FIG. 9.

First, the receiving unit 551 monitors the image data captured by the imaging device 60 and waits until a work content is transmitted by visible light communication (ACT 21; No). Upon receiving the end time from the imaging result of the imaging device 60 (ACT 21; Yes), the receiving unit 551 shifts the process to ACT 22. Subsequent processes in ACT 22 to ACT 24 are the same as those in FIG. 9.

As described above, according to the present embodiment, the end time information can be transmitted from the POS terminal 10 to the server device 50 using visible light communication. Thus, for example, even when the POS terminal 10 operates in a stand-alone manner in accordance with the updating processing, it is possible to notify the server device 50 of the end time information. Thus, the same effect as in the above-described embodiment can be obtained.

Further, when the configuration of the present embodiment is adopted, the transmission unit 152 of the POS terminal 10 becomes unnecessary, and thus, the transmission unit 153 may be made invalid or removed from the POS terminal 10.

The above-described embodiments (first and second embodiments) can be appropriately modified and implemented by partially changing the configuration or function of each device described above. Therefore, hereinafter, some modifications related to the above-described embodiments will be described as other embodiments. In the following, points different from the above-described embodiments will be mainly described, and the detailed descriptions of points common to the already described contents will be omitted. Further, the modifications described below may be implemented individually or may be implemented in combination as appropriate.

(Modification 1)

In the above-described embodiment, the work content being performed on the POS terminal 10 is compared with the work contents registered in the checklist CL1 to determine whether or not the work content is appropriate. However, the determination result may be recorded as a history and used when performing the same maintenance work.

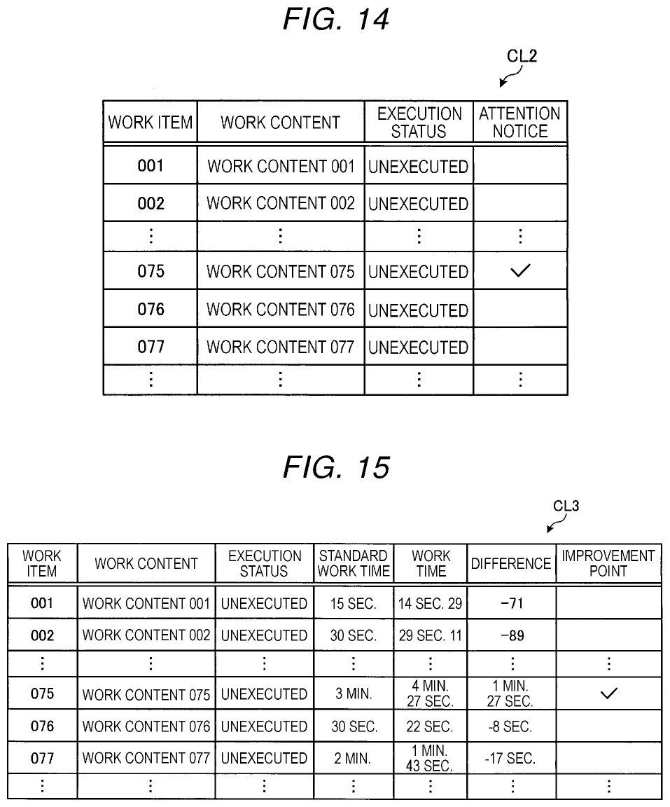

For example, as in a checklist CL2 shown in FIG. 14, flag information may be set as a target of an attention notice for a work item determined to be inappropriate in the maintenance work performed in the past. Here, the history of the work mistake may be the history of the maintenance person using the maintenance terminal 30, or may be the history of an unspecified large number of maintenance persons. FIG. 14 is a diagram illustrating an example of the checklist CL2.

When the checklist CL2 is used, the output unit 353 outputs information for notifying a work item for which flag information is set in the attention notice (hereinafter, also referred to as an attention target item) to the display unit 309 prior to the execution of the work item, thereby prompting the attention of the maintenance person. Specifically, the output unit 353 causes the display unit 309 to display a screen for prompting the attention to an attention target item at the timing when the execution status indicating that the work is completed in the work item immediately before the work item for which the flag information is set in the attention notice (hereinafter, also referred to as the attention target item). For example, the output unit 353 causes the display unit 309 to display a screen describing in detail the work content of the attention target item.

Thus, the maintenance person using the maintenance terminal 30 can easily confirm the work item in which a work mistake occurred in the past by looking at the display unit 309. Therefore, in the present modification, among the works performed by the maintenance person on the POS terminal 10, the work of the attention target item can be performed more carefully, so that a work mistake can be suppressed.

(Modification 2)

In the above-described embodiment, the work content being performed on the POS terminal 10 is compared with the work contents registered in the checklist CL1 to determine whether or not the work content is appropriate. However, the suitability may be determined for other matters related to the maintenance work. For example, the determination unit 352 acquires the time required for the work by the maintenance person (work time) as the work content, and compares the time with the standard time required for the work (hereinafter, standard work time) to determine the suitability (or validity) of the work time.

In this case, for example, the determination unit 352 may perform the determination process using a checklist CL3 illustrated in FIG. 15. Here, FIG. 15 is a diagram illustrating an example of the checklist CL3. As illustrated in FIG. 15, the checklist CL3 holds, for each work item, a work content, an execution status, a standard work time, a work time, a difference, an improvement point, and the like.

Here, the standard work time means a standard time required for work of the work item and is set in advance for each work item. The work time is the time actually required for the work by the maintenance person and is transmitted from the POS terminal 10, together with the work content. As the difference, a value obtained by subtracting the standard work time from the work time is registered. In addition, flag information is registered in the improvement point when the value of the difference exceeds a threshold.

In the POS terminal 10, the work content acquisition unit 151 acquires the time as the work time at each of the start time and the end time of the work, so that the start time and the end time of the work are transmitted by visible light communication, along with the work content.

On the other hand, in the maintenance terminal 30, when the receiving unit 351 receives the work content indicating the start of the work, the determination unit 352 specifies the work content (work item) being performed on the POS terminal 10 as in the above-described embodiment. The execution status is changed to “work in progress”, and the start time is stored. Further, when receiving the work content indicating the end of the work for the same work item, the determination unit 352 changes the execution status to “completed” and registers the time obtained by subtracting the previously stored start time from the end time as the work time.

Further, the determination unit 352 calculates a time obtained by subtracting the standard work time from the time registered as the work time and registers the calculation result as a difference. Then, if the time registered in the difference exceeds a predetermined threshold (for example, one minute), the determination unit 352 determines that the difference is inappropriate and registers the flag information in the improvement point column.

For example, the checklist CL3 in FIG. 12 illustrates an example in which the threshold is set to one minute. In the checklist CL3, since only the difference of the work item “075” exceeds the threshold, the flag information is added to the work item “075”.

In this case, the output unit 353 may display the above-described checklist CL3 as a determination result of the determination unit 352. In addition, the output unit 353 may display a screen for prompting improvement of the work time by, for example, highlighting and displaying the work item for which the flag information is registered in the improvement point column. Also, the output unit 353 may display a screen that clearly indicates work items that were efficiently performed by highlighting and displaying the work items in which the work was completed in a shorter time period than the standard work time.

Thus, the maintenance person using the maintenance terminal 30 can easily grasp the work items for which the work method should be improved and the work items that were able to be performed efficiently by looking at the display unit 309. Therefore, in the present modification, the efficiency of the work performed by the maintenance person on the POS terminal 10 can be improved.

(Modification 3)

In the above-described embodiment, the case where the maintenance terminal 30 records and determines the work status of the POS terminal 10 is described. However, another device connected to the maintenance terminal 30 may record and determine the work status of the POS terminal 10.

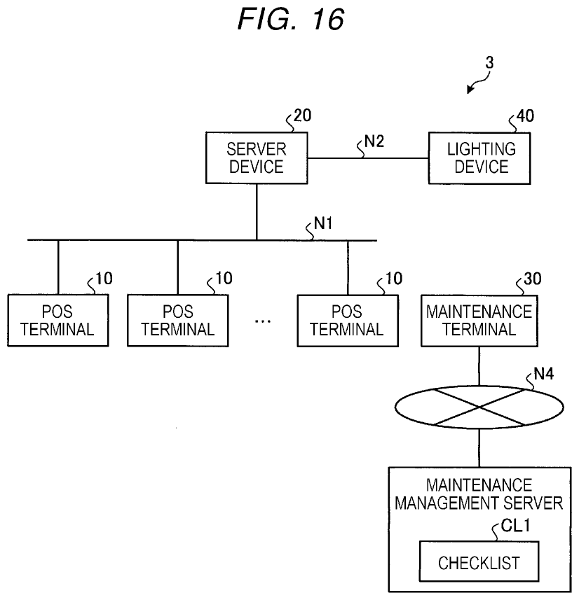

FIG. 16 is a diagram illustrating an example of a maintenance system 3 according to the present modification. In FIG. 16, the maintenance terminal 30 is connected to a maintenance management server 70 via a network N4 such as a public communication network different from the network N1. The maintenance management server 70 is, for example, a server device of a company to which the maintenance person belongs and manages maintenance and inspection work performed by each maintenance person. The maintenance management server 70 has the same hardware configuration as the server device 20 and stores the above-described checklist CL1 and the like in a storage unit (not shown).

In the configuration of FIG. 16, for example, the maintenance management server 70 may record and determine the work status of the POS terminal 10. In this case, the maintenance terminal 30 transmits the work content received by the function of the receiving unit 351 to the maintenance management server 70 via the network N4.

On the other hand, the maintenance management server 70 includes the above-described determination unit 352 and the like as functional units. The determination unit 352 of the maintenance management server 70 performs the same process as the above-described determination unit 352 of the maintenance terminal 30 based on the checklist CL1 and the work content transmitted from the maintenance terminal 30. Then, the process result of the determination unit 352 of the maintenance management server 70 is transmitted to the maintenance terminal 30 and the output unit 353 of the maintenance terminal 30 causes the display unit 309 to display a screen based on the determination result of the determination unit 352.

That is, the maintenance management server 70 functions as an example of the information processing device, acquires the work content being performed on the POS terminal 10 via the maintenance terminal 30, and outputs the determination result on the suitability of the work content via the maintenance terminal 30.

According to this modification, the same effects as those of the above-described embodiments can be obtained. Further, according to the present modification, the maintenance and inspection work performed by each maintenance person can be collectively managed by the maintenance management server 70, and the process load on the maintenance terminal 30 can be reduced, so that the efficiency of the entire system can be improved.

(Modification 4)

In the above-described embodiment, an example in which LEDs are used as the light sources of the backlight 1101 and the lighting device 40 is described, but the type of the light source is not limited thereto. However, it is preferable to use a light source that can be modulated in a high frequency band where human eyes do not sense flickering.

In the above-described embodiment, an example in which visible light communication is performed using the backlight 1101 of the clerk display unit 110 is described. However, the light source of the POS terminal 10 used for visible light communication is not limited thereto. For example, visible light communication may be performed using the backlight of the customer display unit 111. For example, visible light communication may be performed using a light source such as an indicator lamp included in a device such as the printer 112.

(Modification 5)

In the above-described embodiment, the POS terminal 10 performs the visible light communication using both the clerk display unit 110 (backlight 1101) and the light source device of the lighting device 40 connected to the own device. However, the present disclosure is not limited to this configuration, and the POS terminal 10 may be configured to perform visible light communication using one of the light source devices of the clerk display unit 110 (backlight 1101) and the lighting device 40.

In this case, for example, the control unit 100 of the POS terminal 10 may cause the clerk display unit 110 to display a selection screen for selecting a light source device used for visible light communication from the light source devices such as the backlight 1101 and the lighting device 40 connected to the own device. Then, the transmission unit 152, the first modulation unit 153, and the first light source control unit 154 may perform control such that visible light communication is performed using the light source device selected on the selection screen.

(Modification 6)

In the above-described embodiment, the device to be maintained is the POS terminal 10, but the device to be maintained is not limited to the POS terminal 10. For example, devices such as the server device 20 and a personal computer (PC) (not shown) may be targeted for maintenance. Also in this case, by adopting the same system configuration and device configuration as in the above-described embodiments, the same effects as above can be obtained.

(Modification 7)

In the above-described embodiment, the POS terminal 10 performs the visible light communication by the lighting device 40 via the server device 20. However, the present disclosure is not limited thereto, and the POS terminal 10 may directly control the light emission of the lighting device 40. In this case, for example, the POS terminal 10 and the lighting device 40 are connected via a control line or the like, and the first modulation unit 153 and the first light source control unit 154 perform visible light communication using the lighting device 40. Thereby, since the setting contents of the setting change operation performed by the POS terminal 10 can be transmitted to the maintenance terminal 30 by visible light communication by the lighting device 40, the same effect as in the above-described embodiment can be obtained.

When the configuration of the present modification is adopted, the transmission unit 152 of the POS terminal 10 is not required, and thus the transmission unit 152 may be invalidated or removed from the POS terminal 10.

(Modification 8)

In the above-described embodiment, the case where the visible light communication is used for transmitting and receiving the work content is described. However, in an environment where the direct connection between the POS terminal 10 and the maintenance terminal 30 is allowed, the work content may be transmitted and received using a communication method other than the visible light communication.

For example, in an environment where the connection of the maintenance terminal 30 to the network N1 (see FIG. 1) is allowed, the work content transmitted from the POS terminal 10 may be transmitted via the network N1 by connecting the maintenance terminal 30 to the network N1.

In this case, the transmission unit 152 of the POS terminal 10 transmits the work content acquired by the work content acquisition unit 151 to the maintenance terminal 30 via the network N1. The receiving unit 351 of the maintenance terminal 30 receives the work content transmitted from the POS terminal 10 via the network N1.

Further, for example, when the POS terminal 10 and the maintenance terminal 30 include a communication device (hereinafter, referred to as a short-range communication unit) for performing short-range wireless communication such as Bluetooth (registered trademark), the work content may be transmitted and received using the short-range wireless communication.

In this case, the transmission unit 152 of the POS terminal 10 transmits the work content acquired by the work content acquisition unit 151 to the maintenance terminal 30 via the short-range communication unit. The receiving unit 351 of the maintenance terminal 30 receives the work content transmitted from the POS terminal 10 via the short-range communication unit.

According to the present modification, the same effects as those of the above-described embodiments can be obtained. In this modification, since the first modulation unit 153 and the first light source control unit 154 of the POS terminal 10 become unnecessary, the function may be invalidated or removed from the POS terminal 10.

The program executed by each device of the above-described embodiments is provided by being incorporated in a ROM or the like in advance. The program executed by each device of the above-described embodiments may be provided by being recorded on a computer readable recording medium such as a CD-ROM, a flexible disk (FD), a CDR, and a digital versatile disk (DVD) in an installable format or an executable format file.

Furthermore, the program executed by each device of the above-described embodiments may be stored on a computer connected to a network such as the Internet and may be provided by being downloaded via the network. Further, the program executed by each device of the above-described embodiments may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
an acquisition component for acquiring a work content related to a predetermined work item performed on the information processing device to be maintained;
a determination component for determining whether or not the work content acquired by the acquisition component is appropriate based on a checklist that stores a work content serving as a reference for the work item; and
an output component for outputting a determination result of the determination component.

2. The information processing device according to claim 1, wherein
the determination component determines that the work content acquired by the acquisition component is appropriate when the work content matches the work content stored in the checklist.

3. The information processing device according to claim 1, wherein
the checklist stores a work order of a series of work items, and
the determination component determines that the order of the work content acquired by the acquisition component is appropriate when the order of the work content matches the work order stored in the checklist.

4. The information processing device according to claim 1, wherein
the acquisition component acquires a work time required for the work of the work item as the work content, and
the determination component determines the suitability based on a difference between the work time required for the work item acquired by the acquisition component and the work time included in the work content of the corresponding work item stored in the checklist.

5. The information processing device according to claim 1, wherein
the output component outputs, prior to execution of the work item, information for notifying a work item determined to be inappropriate based on a past determination result determined by the determination component.

6. The information processing device according to claim 1, wherein
the information processing device is a maintenance terminal connected to a POS terminal.

7. The information processing device according to claim 1, wherein
the information processing device is a POS terminal.

8. A method of causing a computer of an information processing device to perform functions comprising:
acquiring a work content related to a predetermined work item performed on the information processing device to be maintained;
determining whether or not the work content acquired is appropriate based on a checklist that stores a work content serving as a reference for the work item; and
outputting a determination result from determining whether or not the work content acquired is appropriate.

9. The method according to claim 8, further comprising:
determining that the work content acquired is appropriate when the work content matches the work content stored in the checklist.

10. The method according to claim 8,
the checklist stores a work order of a series of work items, and further comprising:
determining that the order of the work content acquired is appropriate when the order of the work content matches the work order stored in the checklist.

11. The method according to claim 8, further comprising:
acquiring a work time required for the work of the work item as the work content; and
determining the suitability based on a difference between the work time required for the work item acquired and the work time included in the work content of the corresponding work item stored in the checklist.

12. The method according to claim 8, further comprising:
outputting, prior to execution of the work item, information for notifying a work item determined to be inappropriate based on a past determination result determined.

13. A commodity sales system, comprising:
a server;
a POS terminal;
a maintenance terminal, the maintenance terminal, the POS terminal, and the server connected by a network, the maintenance terminal comprising:
an acquisition component for acquiring a work content related to a predetermined work item performed on the commodity sales system to be maintained;
a determination component for determining whether or not the work content acquired by the acquisition component is appropriate based on a checklist that stores a work content serving as a reference for the work item; and
an output component for outputting a determination result of the determination component.

14. The commodity sales system according to claim 13, wherein
the determination component determines that the work content acquired by the acquisition component is appropriate when the work content matches the work content stored in the checklist.

15. The commodity sales system according to claim 13, wherein
the checklist stores a work order of a series of work items, and
the determination component determines that the order of the work content acquired by the acquisition component is appropriate when the order of the work content matches the work order stored in the checklist.

16. The commodity sales system according to claim 13, wherein
the acquisition component acquires a work time required for the work of the work item as the work content, and
the determination component determines the suitability based on a difference between the work time required for the work item acquired by the acquisition component and the work time included in the work content of the corresponding work item stored in the checklist.

17. The commodity sales system according to claim 13, wherein
the output component outputs, prior to execution of the work item, information for notifying a work item determined to be inappropriate based on a past determination result determined by the determination component.

18. The commodity sales system according to claim 13, comprising a plurality of POS terminals.

19. The commodity sales system according to claim 13, wherein the maintenance terminal is connected to the POS terminal by a wireless network.

20. The commodity sales system according to claim 13, wherein the maintenance terminal is connected to the POS terminal by a wired network.
